(19) United States
(12) Patent Application Publication
(10) Pub. No.: US 2025/0150307 A1
(43) Pub. Date: May 8, 2025

(54) DIFFUSION MODEL BASED WIRELESS CHANNEL ESTIMATION

(71) Applicant: Samsung Electronics Co., Ltd., Suwon-si (KR)

(72) Inventors: Xiaochuan Ma, Hillsborough, NJ (US); Yan Xin, Princeton, NJ (US); Yong Ren, Warren, NJ (US); Daoud Burghal, San Jose, CA (US); Hao Chen, Allen, TX (US); Jianzhong Zhang, Dallas, TX (US)

(21) Appl. No.: 18/905,944

(22) Filed: Oct. 3, 2024

Related U.S. Application Data
(60) Provisional application No. 63/597,277, filed on Nov. 8, 2023.

(51) Int. Cl. H04L 25/02

(52) U.S. Cl. CPC H04L 25/024

(57) ABSTRACT

An apparatus includes a transceiver configured to receive, over a wireless communication channel, at least one controlled-noise signal. The apparatus also includes a processor, operatively coupled to the transceiver. The processor is configured to train, based on the at least one controlled-noise signal, a noise prediction model for the wireless communication channel, and generate, based on the trained noise prediction model, a noise prediction for the wireless communication channel. The processor is also configured to determine, based on the received at least one controlled-noise signal and the noise prediction, a score function for the wireless communication channel.

### CROSS-REFERENCE TO RELATED APPLICATION(S) AND CLAIM OF PRIORITY

This application claims priority under 35 U.S.C. § 119 (e) to U.S. Provisional Patent Application No. 63/597,277 filed on Nov. 8, 2023. The above-identified provisional patent application is hereby incorporated by reference in its entirety.

### TECHNICAL FIELD

This disclosure relates generally to wireless networks. More specifically, this disclosure relates to diffusion model based wireless channel estimation.

### BACKGROUND

A wireless channel is a dynamic medium through which signals are transmitted, and the channel can be affected by factors such as multi-path fading, interference, noise, and mobility. Channel estimation serves as a critical process to track and adapt to these dynamic changes, allowing a communication system to optimize its performance. In essence, channel estimation involves the estimation of channel parameters, such as amplitude, phase, and delay, which are used by a receiver to demodulate and decode transmitted signals accurately.

### SUMMARY

This disclosure provides methods and apparatuses for diffusion model based wireless channel estimation.

In one embodiment, an apparatus is provided. The apparatus includes a transceiver configured to receive, over a wireless communication channel, at least one controlled-noise signal. The apparatus also includes a processor, operatively coupled to the transceiver. The processor is configured to train, based on the at least one controlled-noise signal, a noise prediction model for the wireless communication channel, and generate, based on the trained noise prediction model, a noise prediction for the wireless communication channel. The processor is also configured to determine, based on the received at least one controlled-noise signal and the noise prediction, a score function for the wireless communication channel.

In another embodiment, a method is provided. The method includes receiving, over a wireless communication channel, at least one controlled-noise signal, and training, based on the at least one controlled-noise signal, a noise prediction model for the wireless communication channel. The method also includes generating, based on the trained noise prediction model, a noise prediction for the wireless communication channel, and determining, based on the received at least one controlled-noise signal and the noise prediction, a score function for the wireless communication channel.

In yet another embodiment, a non-transitory computer readable medium embodying a computer program is provided. The computer program includes program code that, when executed by a processor of a device, causes the device to receive, over a wireless communication channel, at least one controlled-noise signal, and train, based on the at least one controlled-noise signal, a noise prediction model for the wireless communication channel. The program code, when executed by the processor of the device, also causes the device to generate, based on the trained noise prediction model, a noise prediction for the wireless communication channel, and determine, based on the received at least one controlled-noise signal and the noise prediction, a score function for the wireless communication channel.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example of components used for DDPM-based channel estimation according to embodiments of the present disclosure;

FIG. 5 illustrates an example method for DDPM-based channel estimation according to embodiments of the present disclosure;

FIG. 6 illustrates an example of components used for an enhanced DDPM-based channel estimation according to embodiments of the present disclosure;

FIG. 7 illustrates an example method for an enhanced DDPM-based channel estimation according to embodiments of the present disclosure;

FIG. 8 illustrates an example of components used for DDIM-based channel estimation according to embodiments of the present disclosure;

FIG. 9 illustrates an example method for DDIM-based channel estimation according to embodiments of the present disclosure; and

FIG. 10 illustrates an example method for diffusion model based wireless channel estimation according to embodiments of the present disclosure.

### DETAILED DESCRIPTION

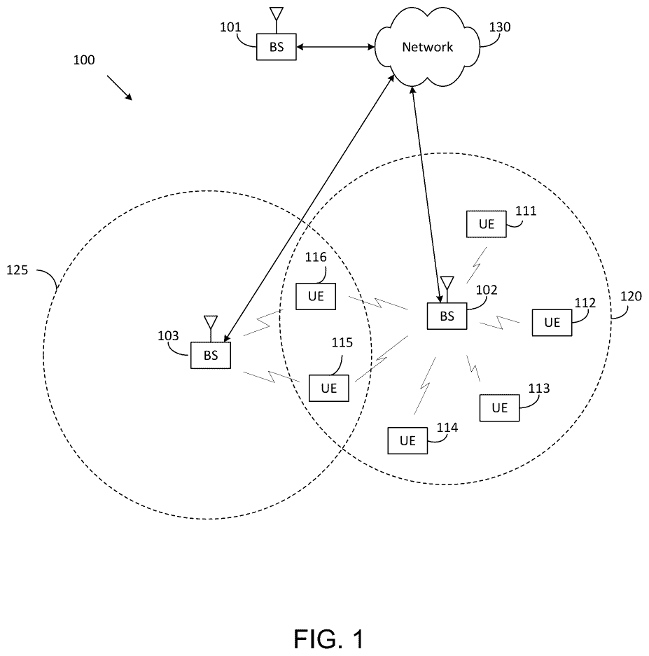

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for diffusion model based wireless channel estimation. In certain embodiments, one or more of the gNBs 101-103 includes circuitry, programing, or a combination thereof, to support diffusion model based wireless channel estimation in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

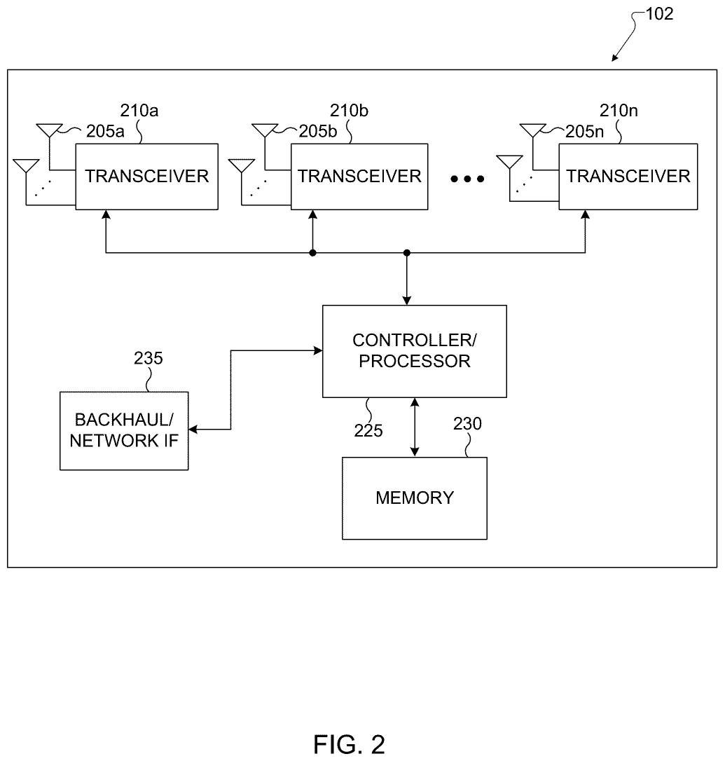

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support diffusion model based wireless channel estimation as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

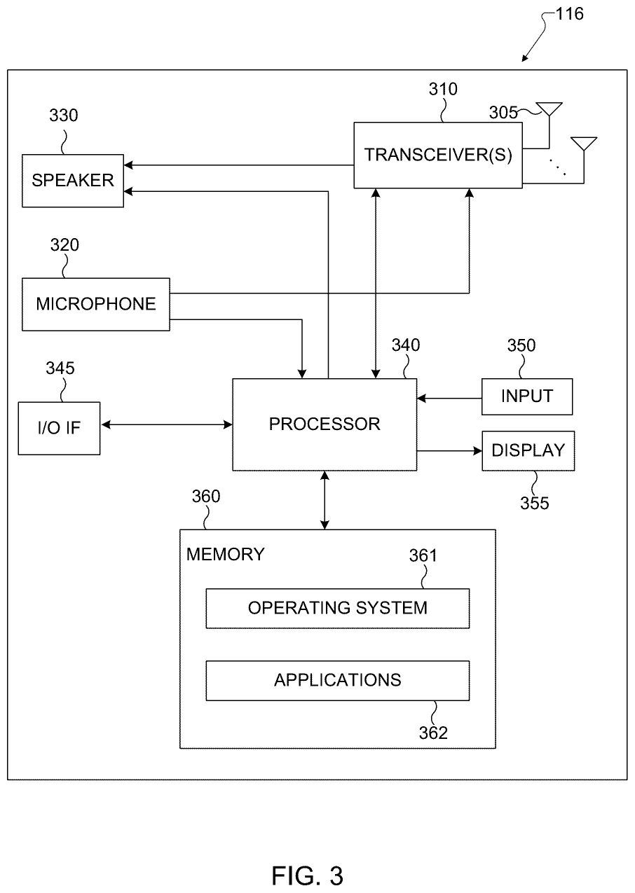

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for diffusion model based wireless channel estimation as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

In the realm of wireless communication, channel estimation is a an important process that plays a pivotal role in ensuring the reliable transmission of data between transmitters and receivers. Wireless communication systems are inherently susceptible to various impairments and variations in the radio propagation environment, leading to fluctuations in the channel characteristics. Channel estimation seeks to mitigate the adverse effects of these variations by providing accurate information about the current state of the communication channel.

Some methods for channel estimation often rely on pilot signals, which are known symbols inserted into the transmitted signal, allowing the receiver to measure the channel response at specific points in time. These measurements are then used to interpolate the channel characteristics between pilot symbols, thus providing an estimate of the channel conditions.

Various embodiments of the present disclosure recognize that the integration of machine learning techniques into channel estimation processes can improve the accuracy and efficiency of channel estimation. Machine learning-based channel estimation leverages the power of artificial intelligence and data-driven approaches to adapt and learn from the wireless channel's behavior, making the channel estimation more robust to varying conditions and potentially reducing the need for explicit pilot signals.

Some machine learning-based channel estimation methods include:
1. Deep Learning Approaches: Deep neural networks, including convolutional neural networks (CNNs) and recurrent neural networks (RNNs), have been applied to channel estimation tasks. These networks can learn complex relationships between received signals and the channel characteristics, allowing for accurate and efficient estimation.
2. Reinforcement Learning: Reinforcement learning techniques can be used to optimize the transmission and reception strategies in response to changing channel conditions, effectively improving channel estimation and overall system performance.
3. Autoencoders: Autoencoders are neural network architectures that can be used for unsupervised learning of channel representations. Autoencoders can capture channel characteristics and reduce the reliance on pilot signals.
4. Transfer Learning: Transfer learning techniques enable the adaptation of pre-trained models to specific channel environments, enhancing the generalization of channel estimation algorithms across different scenarios.
5. Diffusion model: A diffusion model includes denoising diffusion probabilistic models (DDPM) and score matching with Langevin dynamics (SMLD). In some implementations, based on the SMLD algorithm, the channel estimation solution first learns a score function of the channel data using denoising score matching, obtains a close-form score function of the likelihood, and finally completes a posterior sampling process following the annealed Langevin dynamics.

Machine learning-based channel estimation methods can make wireless communication systems more adaptive, efficient, and robust, particularly in challenging environments. As the field of machine learning continues to advance, these methods are expected to play an increasingly important role in optimizing wireless communication systems for a wide range of applications, including 5G, IoT, and beyond.

Various embodiments of the present disclosure provide a diffusion model-based channel estimation method. The diffusion model is used to learn the score function of a data distribution. Then, the information from the score function and channel observations are used to estimate the wireless channel response. The disclosed diffusion-based channel estimation method improves over the channel estimation performance of other methods.

Channel estimation is a process of estimating the characteristics of a wireless communication channel, such as its frequency response, delay spread, and fading coefficients. Channel estimation is important for coherent detection and decoding of the transmitted signals, as well as for optimization of the transmission parameters, such as power allocation, modulation scheme, and coding rate. Channel estimation can improve the accuracy and reliability of the received signals, and increase the capacity and performance of wireless communication systems.

However, various embodiments of the present disclosure recognize that channel estimation is also challenging, especially for high-dimensional signals that involve multiple signals that involve multiple antennas, multiple subcarriers and multiple users. The channel estimation problem can be formulated as finding the optimal solution of a system of equations that relate the transmitted and received signals with the channel coefficients and the noise. The complexity and difficulty of this problem depend on the number and arrangement of the channel of the channel coefficients, the availability and quality of the pilot signals, the noise level and distribution, and the channel dynamics and variations. This problem may be addressed by some approaches, such as linear interpolation, least squares, minimum mean square error, maximum likelihood, Bayesian interference, and deep learning.

In certain embodiments of the present disclosure, the channel estimation problem can be solved in the following form. In the frequency domain, the input-output relationship at pilot tones (subcarrier) between transmitted and received signals can be expressed as

$$Y = H ⊙ X + N , \qquad Eq . ( 1 )$$

where Y∈ [symbol] are the received signals at pilot tones, H∈ [symbol] is the channel matrix, ⊚ represents the Hadamard product that is an element-wise product, X∈ [symbol] are the transmitted pilot signals known to the receiver, and N∈ [symbol] is an additive white Gaussian noise (AWGN).

In particular, the mathematical model described in Eq. (1) is applicable to different types of signal models (e.g., including, but not limited to single-input single output [SISO], single-input multiple-output [SIMO], and multiple-input multiple-output [MIMO] cases etc.). For example, in a SIMO signal model, N_{fp} and N_{fn} can be used to represent the number of the pilot tones (subcarriers) in the frequency domain over one OFDM symbol and the number of the received antennas, respectively, while in a SISO case, N_{fp} and N_{fn} can be used to represent the number of the pilot tones (subcarriers) in the frequency domain over one OFDM symbol and the number of the OFDM symbols containing pilot tones, respectively. Note that MIMO signal models can be readily converted to a SIMO case where pilot signals from different transmitted antennas are separated in time, frequency, or code domains.

The goal of the channel estimation task is to estimate H based on pilot signals X and received signals Y. Without loss of generality, pilot signals X are assumed to be an identity matrix and thus the signal model in Eq. (1) can be rewritten as

$$\tilde{H} = H + N .$$

Note that the described processes in this disclosure can be readily applied to the case where pilot signals X are not an identity matrix.

As previously described herein, a DDPM may be utilized to perform channel estimation. The diffusion process can be represented as the follow equations:

$$\{ \begin{matrix}dx = - \frac{1}{2} β ( t ) xdt + \sqrt{β ( t ) dw} Forward diffusion SDE \\ dx = [ - \frac{1}{2} β ( t ) x - β ( t ) {∇}_{x} log p ( x ) ] dt + \sqrt{β ( t )} dw Reverse diffusion SDE\end{matrix}$$

Following the forward diffusion stochastic differential equation (SDE), a structured signal gradually becomes pure noise. Following the reverse diffusion SDE, signals following distribution p(x) can be generated from pure noise.

Assuming α̅ₜ=Πₛ₌₁^{t}(1−βₛ), αₜ=1−βₜ, x₀˜training set, the discrete diffusion process in DDPM is defined as

$$\{ \begin{matrix}{x}_{t} = \sqrt{{\overline{α}}_{t}} {x}_{0} + \sqrt{( 1 - {\overline{α}}_{t} )} ϵ , where {ϵ}_{t - 1} ∼ 𝒩 ( 0 , I ) Forward Process \\ \begin{matrix}{x}_{t - 1} = \frac{1}{\sqrt{{α}_{t}}} ( {x}_{t} - \frac{1 - {α}_{t}}{\sqrt{1 - {\overline{α}}_{t}}} {ϵ}_{θ} ( {x}_{t} , t ) ) + \sqrt{( 1 - {α}_{t} )} {z}_{t} , \\ where {z}_{t} ∼ 𝒩 ( 0 , I ) Backward process\end{matrix}\end{matrix}$$

One important fact used in the reverse backward process is

$$- \frac{1}{\sqrt{1 - {\overline{α}}_{t}}} {ϵ}_{θ} ( {x}_{t} , t ) \approx {∇}_{{x}_{t}} log P ( {x}_{t} )$$

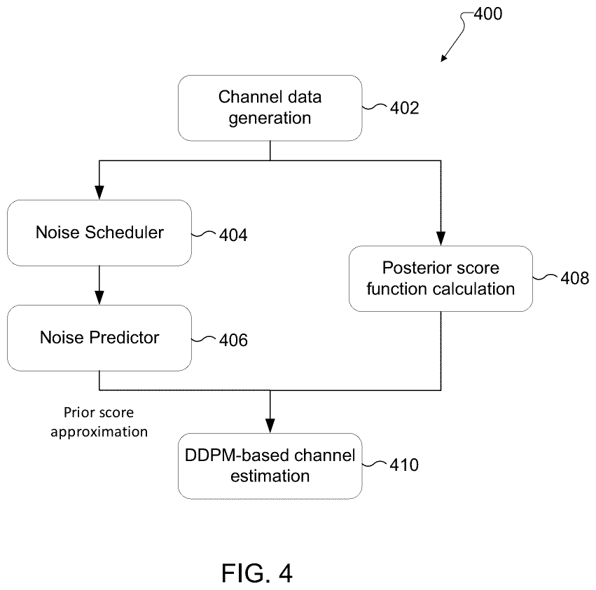

In one embodiment, channel estimation is performed based on a DDPM using the components shown in FIG. 4.

FIG. 4 illustrates an example 400 of components used for DDPM-based channel estimation 410 according to embodiments of the present disclosure. The embodiment of components used for DDPM-based channel estimation of FIG. 4 is for illustration only. Different embodiments of components used for DDPM-based channel estimation could be used without departing from the scope of this disclosure.

In the example of FIG. 4, DDPM-based channel estimation 410 utilizes data obtained by channel data generation 402. Channel data generation refers to a process to obtain the channel response data or received signal data. In addition to obtaining the channel response data or received signal data, channel data generation 402 also estimates and stores some additional information (meta data) about the channel or received signals, e.g., signal to noise ratio (SNR) or transmission power. The data gathered during channel data generation 402 can be obtained by channel simulation based on wireless channel models, or measurements conducted in the field for a deployed system. This data is used by noise scheduler 404 to train noise predictor 406 and the calculation of the posterior score function calculation 408.

In the training of noise predictor 406, the data gathered by channel data generation 402 is directly used in the training of a noise prediction model (e.g., a neural network). For posterior score function calculation 408, the score function of the posterior probability is calculated (which normally has a close-form calculation formula) with the meta data (e.g. the SNR or signal power) gathered by channel data generation 402. With a well-trained noise predictor 406 and the score function of the posterior probability, the true channel response or received signals can be estimated from a noisy channel response or noisy received data by DDPM-based channel estimation 410.

Although FIG. 4 illustrates an example 400 of components used for DDPM-based channel estimation 410, various changes may be made to FIG. 4. For example, various additional components could be used for DDPM-based channel estimation 410 according to particular needs.

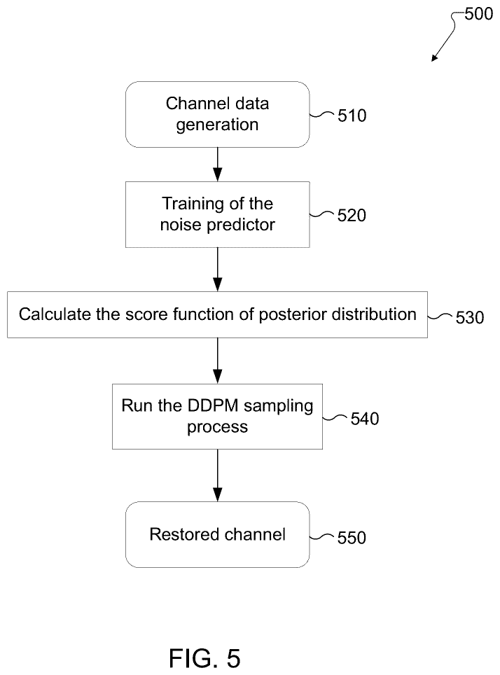

FIG. 5 illustrates an example method for DDPM-based channel estimation 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for DDPM-based channel estimation could be used without departing from the scope of this disclosure.

In the example of FIG. 5 a DDPM-based channel estimation (e.g., DDPM-based channel estimation 410 of FIG. 4) begins at step 510. At step 510, an apparatus such as gNB 102 of FIG. 1 performs channel data generation. For example, the channel data generation may be similar to channel data generation 402 of FIG. 4.

At step 520, a noise predictor such as noise predictor 406 of FIG. 4 is trained according to a noise scheduler such as noise scheduler 404 of FIG. 4. The noise scheduler and noise predictor may be included in the apparatus of step 510 or may be components of one or more separate apparatuses. To train the noise predictor, first hyperparameters are selected, such a number of diffusion steps, T, and a noise schedule {βₜ}_{0≤t≤T}. The selection of {βₜ}_{0≤t≤T} can follow a linear or cosine schedule. In the linear schedule,

$${β}_{t} = \frac{{β}_{end} - {β}_{start}}{T} \cdot t + {β}_{start} ,$$

where {β_{end}, βₛₜₐᵣₜ} are hyperparameters that are selected. The corresponding values αₜ=1−β₆ and α̅ₜ=Πₛ₌₁^{t}αₛ can be calculated given {βₜ}_{0≤t≤T}. In the cosine schedule,

$${\overline{α}}_{t} = \frac{f ( t )}{f ( 0 )} , f ( t ) = cos {( \frac{\frac{t}{T} + s}{1 + s} \cdot \frac{π}{2} )}^{2} ,$$

and the corresponding

$${β}_{t} = 1 - \frac{{\overline{α}}_{t}}{{\overline{α}}_{t - 1}} , {α}_{t} = 1 - {β}_{t} .$$

Using the channel dataset q(h₀), the noise predictor model can be trained (the model can be a neural network or any machine learning model) following Algorithm 1 below.

Algorithm 1: Training a neural network ϵ_{θ} to learn the noise

```
  repeat
  h₀~q(h₀)
  t~Uniform(1, ... , T)
  ϵ~ [symbol] (0, I)
  Take gradient descent step on
  ${∇}_{θ} {‖ ϵ - {ϵ}_{θ} ( \sqrt{{\overline{α}}_{t}} {h}_{0} + \sqrt{1 - {\overline{α}}_{t}} ϵ , t ) ‖}^{2}$
  until converged
```

At step 530, the apparatus of step 510 or another apparatus calculates the score function of the posterior distribution as follows:

Given the noisy channel \tilde{h}, channel noise power σ² (which can be calculated using \tilde{h} and the SNR), and DDPM noise schedule (e.g., from noise scheduler 404 of FIG. 4) the score function of the likelihood score distribution is calculated as

$${∇}_{{h}_{t}} log \tilde{p} ( \tilde{h} \vert {h}_{t} ) = \frac{1}{\sqrt{{\overline{α}}_{t}} ( {σ}^{2} + \frac{1 - {\overline{α}}_{t}}{{\overline{α}}_{t}} )} ( \tilde{h} - \frac{1}{\sqrt{{\overline{α}}_{t}}} {h}_{t} ) .$$

Then, the posterior score function can be calculated as

$${∇}_{{h}_{t}} log \tilde{p} ( {h}_{t} \vert \tilde{h} ) = {∇}_{{h}_{t}} log \tilde{p} ( \tilde{h} \vert {h}_{t} ) + {∇}_{{h}_{t}} log \tilde{p} ( {h}_{t} ) .$$

Here, the prior score function can be approximated as

$${∇}_{{h}_{t}} log \tilde{p} ( {h}_{t} ) = - \frac{1}{\sqrt{1 - {\overline{α}}_{t}}} {ϵ}_{θ} ( {h}_{t} , t ) .$$

At step 540, the apparatus of step 510 or another apparatus runs a DDPM sampling process. In the DDPM sampling process, given the SNR and the well-trained noise predictor, the channel response can be restored at step 550 following Algorithm 2 below. Here, λ is a scaling factor for the likelihood score distribution.

Algorithm 2: Posterior Sampling

| Require: Channel noise power σ², noisy channel \tilde{h} | | |
|---|---|---|
| | h_{T}~ [symbol] (0, I) | |
| | for t = T to 1 do | |
| | | zₜ~N(0, 1) if t > 0, else z₀ = 0 |
| | | ${h}_{t - 1} = \frac{1}{\sqrt{{α}_{t}}} ( {h}_{t} - \frac{1 - {α}_{t}}{\sqrt{1 - {\overline{α}}_{t}}} {ϵ}_{θ} ( {h}_{t} , t ) ) + \sqrt{1 - {\overline{α}}_{t}} {z}_{t}$ ${∇}_{{h}_{t}} log \tilde{p} ( \tilde{h} \vert {h}_{t} ) = \frac{1}{\sqrt{{α}_{t}} ( {σ}^{2} + \frac{1 - {\overline{α}}_{t}}{{\overline{α}}_{t}} )} ( \tilde{h} - \frac{1}{\sqrt{{\overline{α}}_{t}}} {h}_{t} )$ ${h}_{t - 1} = {h}_{t - 1} + λ \frac{1 - {α}_{t}}{\sqrt{{α}_{t}}} {∇}_{{h}_{t}} log \tilde{p} ( \tilde{h} \vert {h}_{t} )$ |

end for
Output: h₀

Using the validation data set, the performance of the provided enhanced DDPM-based channel estimation method with different hyperparameters (including the scaling factor for the likelihood score distribution λ, number of diffusion steps T, noise schedule {βₜ}_{0≤t≤T}, and the neural network structure and hyperparameters) can be compared and eventually the setting which has the best optimized performance can be selected.

Although FIG. 5 illustrates one example method for DDPM-based channel estimation 500, various changes may be made to FIG. 5. For example, while shown as a series of steps, various steps in FIG. 5 could overlap, occur in parallel, occur in a different order, occur any number of times, be omitted, or replaced by other steps.

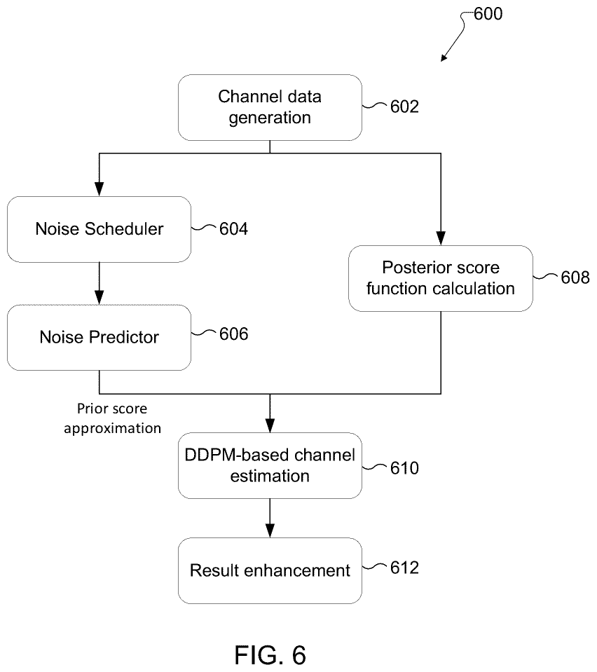

In one embodiment, channel estimation is performed based on an Enhanced DDPM using the components shown in FIG. 6.

FIG. 6 illustrates an example 600 of components used for an enhanced DDPM-based channel estimation 612 according to embodiments of the present disclosure. The embodiment of components used for an enhanced DDPM-based channel estimation of FIG. 6 is for illustration only. Different embodiments of components used for an enhanced DDPM-based channel estimation could be used without departing from the scope of this disclosure.

The enhanced DDPM-based channel estimation 612 is an extension of DDPM-based channel estimation 410 described regarding FIG. 4. In the Example of FIG. 6, DDPM-based channel estimation 610 utilizes data obtained by channel data generation 602. As previously described herein, channel data generation refers to a process to obtain the channel response data or received signal data. In addition to obtaining the channel response data or received signal data, channel data generation 602 also estimates and stores some additional information (meta data) about the channel or received signals, e.g., signal to noise ratio (SNR) or transmission power. The data gathered during channel data generation 602 can be obtained by channel simulation based on wireless channel models, or measurements conducted in the field for a deployed system. This data is used by noise scheduler 604 to train noise predictor 606 and the calculation of the posterior score function calculation 608.

In the training of noise predictor 606, the data gathered by channel data generation 602 is directly used in the training of a noise prediction model (e.g., a neural network). For posterior score function calculation 608, the score function of the posterior probability is calculated (which normally has a close-form calculation formula) with the meta data (e.g. the SNR or signal power) gathered by channel data generation 602. With a well-trained noise predictor 406 and the score function of the posterior probability, the true channel response or received signals can be estimated from a noisy channel response or noisy received data by DDPM-based channel estimation 610.

One difference between enhanced DDPM-based channel estimation 612 and DDPM-based channel estimation 410 is that in enhanced DDPM-based channel estimation 612, the performance of the DDPM-based channel estimation 610 algorithm is enhanced by summarizing the channel estimation results obtained by implementing the DDPM-based channel estimation 610 for multiple iterations. The final result (enhanced DDPM-based channel estimation 612) can be any reasonable statistics of the multiple channel estimation results, e.g., the sample mean, median, etc.

Although FIG. 6 illustrates an example 600 of components used for enhanced DDPM-based channel estimation 612, various changes may be made to FIG. 6. For example, various additional components could be used for enhanced DDPM-based channel estimation 612 according to particular needs.

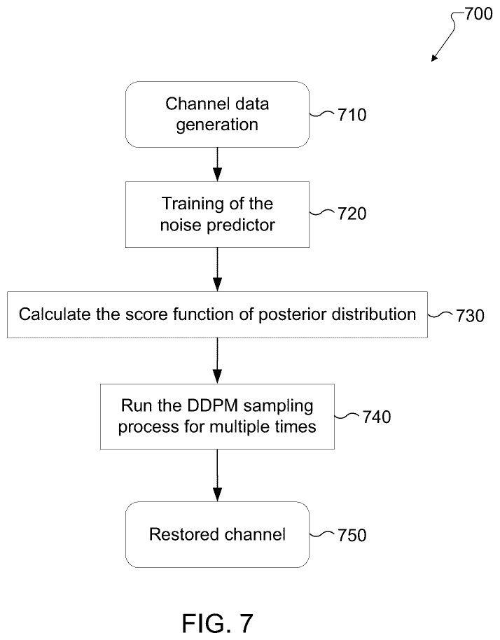

FIG. 7 illustrates an example method for an enhanced DDPM-based channel estimation 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for DDPM-based channel estimation could be used without departing from the scope of this disclosure.

In the example of FIG. 5 a DDPM-based channel estimation (e.g., DDPM-based channel estimation 610 of FIG. 6) begins at step 710. At step 710, an apparatus such as gNB 102 of FIG. 1 performs channel data generation. For example, the channel data generation may be similar to channel data generation 602 of FIG. 6.

At step 720, a noise predictor such as noise predictor 606 of FIG. 6 is trained according to a noise scheduler such as noise scheduler 604 of FIG. 6. The noise scheduler and noise predictor may be included in the apparatus of step 710 or may be components of one or more separate apparatuses. To train the noise predictor, first hyperparameters are selected, such a number of diffusion steps, T, and a noise schedule {βₜ}_{0≤t≤T}. The selection of {βₜ}_{0≤t≤T} can follow a linear or cosine schedule. In the linear schedule,

$${β}_{t} = \frac{{β}_{end} - {β}_{start}}{T} \cdot t + {β}_{start} ,$$

where {β_{end}, βₛₜₐᵣₜ} are hyperparameters that are selected. The corresponding values αₜ=1−βₜ and α̅ₜ=Πₛ₌₁^{t} αₛ as can be calculated given {βₜ}_{0≤t≤T}. In the cosine schedule,

$${\overline{α}}_{t} = \frac{f ( t )}{f ( 0 )} , f ( t ) = cos {( \frac{\frac{t}{T} + s}{1 + s} \cdot \frac{π}{2} )}^{2} ,$$

and the corresponding

$${β}_{t} = 1 - \frac{{\overline{α}}_{t}}{{\overline{α}}_{t - 1}} , {α}_{t} = 1 - {β}_{t} .$$

Using the channel dataset q(h₀), the noise predictor model can be trained (the model can be a neural network or any machine learning model) following Algorithm 1 described regarding FIG. 5.

At step 730, the apparatus of step 710 or another apparatus calculates the score function of the posterior distribution as follows:

Given the noisy channel \tilde{h}, channel noise power σ² (which can be calculated using \tilde{h} and the SNR), and DDPM noise schedule (e.g., from noise scheduler 604 of FIG. 6) the score function of the likelihood score distribution is calculated as

$${∇}_{{h}_{t}} log \tilde{p} ( \tilde{h} \vert {h}_{t} ) = \frac{1}{\sqrt{{\overline{α}}_{t}} ( {σ}^{2} + \frac{1 - {\overline{α}}_{t}}{{\overline{α}}_{t}} )} ( \tilde{h} - \frac{1}{\sqrt{{\overline{α}}_{t}}} {h}_{t} ) .$$

Then, the posterior score function can be calculated as

$${∇}_{{h}_{t}} log \tilde{p} ( {h}_{t} \vert \tilde{h} ) = {∇}_{{h}_{t}} log \tilde{p} ( \tilde{h} \vert {h}_{t} ) + {∇}_{{h}_{t}} log \tilde{p} ( {h}_{t} ) .$$

Here, the prior score function can be approximated as

$${∇}_{{h}_{t}} log \tilde{p} ( {h}_{t} ) = - \frac{1}{\sqrt{1 - {\overline{α}}_{t}}} {ϵ}_{θ} ( {h}_{t} , t ) .$$

At step 740, the apparatus of step 710 or another apparatus runs a DDPM sampling process. In the DDPM sampling process, given the SNR and the well-trained noise predictor, the channel response can be restored following Algorithm 2 described regarding FIG. 5. Step 740 is repeated for a number of iterations M. the results are stored as {h_{0,1}, . . . , h_{0,M}}.

At step 750, the final estimation result is calculated as the sample mean of the M estimations of the channel response.

Using the validation data set, the performance of the provided enhanced DDPM-based channel estimation method with different hyperparameters (including the scaling factor for the likelihood score distribution λ, number of diffusion steps T, noise schedule {βₜ}_{0≤t≤T}, and the neural network structure and hyperparameters) can be compared and eventually the setting which has the best optimized performance can be selected.

Although FIG. 7 illustrates one example method for enhanced DDPM-based channel estimation 700, various changes may be made to FIG. 7. For example, while shown as a series of steps, various steps in FIG. 7 could overlap, occur in parallel, occur in a different order, occur any number of times, be omitted, or replaced by other steps.

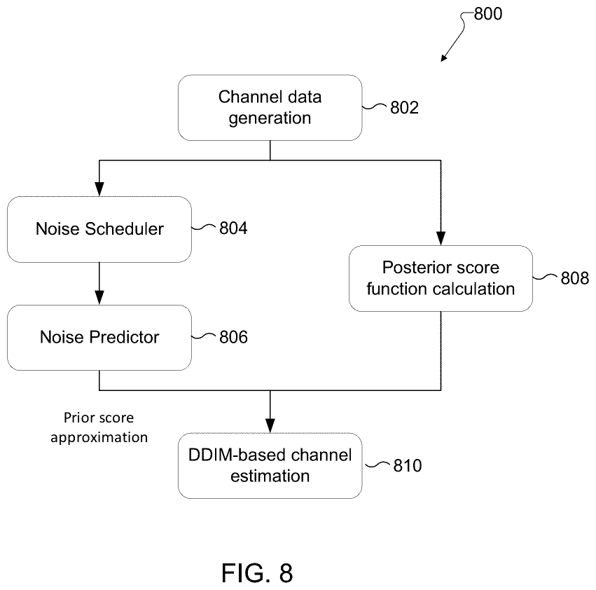

In one embodiment, channel estimation is performed based on a denoising diffusion implicit model (DDIM) using the components shown in FIG. 8.

FIG. 8 illustrates an example 800 of components used for DDIM-based channel estimation 810 according to embodiments of the present disclosure. The embodiment of components used for DDIM based channel estimation of FIG. 8 is for illustration only. Different embodiments of components used for DDIM based channel estimation could be used without departing from the scope of this disclosure.

DDIM based channel estimation 810 is a variation of DDPM-based channel estimation 410 described regarding FIG. 4. In the Example of FIG. 8, DDIM-based channel estimation 810 utilizes data obtained by channel data generation 802. As previously described herein, channel data generation refers to a process to obtain the channel response data or received signal data. In addition to obtaining the channel response data or received signal data, channel data generation 802 also estimates and stores some additional information (meta data) about the channel or received signals, e.g., signal to noise ratio (SNR) or transmission power. The data gathered during channel data generation 802 can be obtained by channel simulation based on wireless channel models, or measurements conducted in the field for a deployed system. This data is used by noise scheduler 804 to train noise predictor 806 and the calculation of the posterior score function calculation 808.

In the training of noise predictor 806, the data gathered by channel data generation 802 is directly used in the training of a noise prediction model (e.g., a neural network). For posterior score function calculation 808, the score function of the posterior probability is calculated (which normally has a close-form calculation formula) with the meta data (e.g. the SNR or signal power) gathered by channel data generation 802. With a well-trained noise predictor 406 and the score function of the posterior probability, the true channel response or received signals can be estimated from a noisy channel response or noisy received data by DDIM-based channel estimation 810. One difference between DDIM-based channel estimation 810 and DDPM-based channel estimation 410 is that in DDIM-based channel estimation 810, the performance of the diffusion-based channel estimation algorithm is enhanced by applying DDIM sampling in the channel estimation, which has the advantages of lower complexity and better channel estimation performance.

Although FIG. 8 illustrates an example 800 of components used for DDIM-based channel estimation 810, various changes may be made to FIG. 8. For example, various additional components could be used for DDIM-based channel estimation 810 according to particular needs.

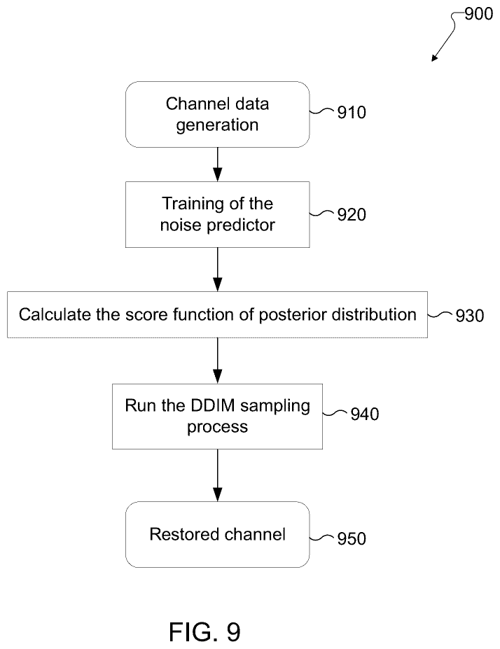

FIG. 9 illustrates an example method for DDIM-based channel estimation 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for DDIM-based channel estimation could be used without departing from the scope of this disclosure.

In the example of FIG. 9 a DDIM-based channel estimation (e.g., DDIM-based channel estimation 810 of FIG. 8) begins at step 910. At step 910, an apparatus such as gNB 102 of FIG. 1 performs channel data generation. For example, the channel data generation may be similar to channel data generation 802 of FIG. 8.

At step 920, a noise predictor such as noise predictor 806 of FIG. 8 is trained according to a noise scheduler such as noise scheduler 804 of FIG. 8. The noise scheduler and noise predictor may be included in the apparatus of step 910 or may be components of one or more separate apparatuses. To train the noise predictor, first hyperparameters are selected, such a number of diffusion steps, T, and a noise schedule {βₜ}_{0≤t≤T}. The selection of {βₜ}_{0≤t≤T} can follow a linear or cosine schedule. In the linear schedule,

$${β}_{t} = \frac{{β}_{end} - {β}_{start}}{T} \cdot t + {β}_{start} ,$$

where {β_{end}, βₛₜₐᵣₜ} are hyperparameters that are selected. The corresponding values αₜ=1−βₜ and α̅ₜ=Πₛ₌₁^{t} αₛ can be calculated given {βₜ}_{0≤t≤T}. In the cosine schedule,

$${\overline{α}}_{t} = \frac{f ( t )}{f ( 0 )} , f ( t ) = cos {( \frac{\frac{t}{T} + s}{1 + s} \cdot \frac{π}{2} )}^{2} ,$$

and the corresponding

$${β}_{t} = 1 - \frac{{\overline{α}}_{t}}{{\overline{α}}_{t - 1}} , {α}_{t} = 1 - {β}_{t} .$$

Using the channel dataset q(h₀), the noise predictor model can be trained (the model can be a neural network or any machine learning model) following Algorithm 1 described regarding FIG. 5.

At step 930, the apparatus of step 910 or another apparatus calculates the score function of the posterior distribution as follows:

Given the noisy channel \tilde{h}, channel noise power σ² (which can be calculated using \tilde{h} and the SNR), and DDPM noise schedule (e.g., from noise scheduler 804 of FIG. 8) the score function of the likelihood score distribution is calculated as

$${∇}_{{h}_{t}} log \tilde{p} ( \tilde{h} \vert {h}_{t} ) = \frac{1}{\sqrt{{\overline{α}}_{t}} ( {σ}^{2} + \frac{1 - {\overline{α}}_{t}}{{\overline{α}}_{t}} )} ( \tilde{h} - \frac{1}{\sqrt{{\overline{α}}_{t}}} {h}_{t} ) .$$

Then, the posterior score function can be calculated as

$${∇}_{{h}_{t}} log \tilde{p} ( {h}_{t} \vert \tilde{h} ) = {∇}_{{h}_{t}} log \tilde{p} ( \tilde{h} \vert {h}_{t} ) + {∇}_{{h}_{t}} log \tilde{p} ( {h}_{t} ) .$$

Here, the prior score function can be approximated as

$${∇}_{{h}_{t}} log \tilde{p} ( {h}_{t} ) = - \frac{1}{\sqrt{1 - {\overline{α}}_{t}}} {ϵ}_{θ} ( {h}_{t} , t ) .$$

At step 940, the apparatus of step 910 or another apparatus selects an S-long subsequence [τ₁, τ₂, . . . , τ_{S}] from time steps [1, 2, . . . , T]. One possible subsequence can be generated following a uniform way as [1, T/M, 2T/M, . . . , T], where M is an integer and T=MS. In the DDIM sampling process, given the SNR and the well-trained noise predictor, the channel response can be restored at step 950 following Algorithm 3 below. Here, λ is a scaling factor for the likelihood score distribution.

Algorithm 3: DDIM channel estimation

Require: Channel noise power σ², noisy channel \tilde{h}

| h_{T}~ [symbol] (0, I) | |
|---|---|
| for t = τ_{S} to τ₁ do | |
| | ${h}_{t - 1} = \frac{\sqrt{{\overline{α}}_{τ - 1}}}{\sqrt{{\overline{α}}_{t}}} ( {h}_{t} - \sqrt{1 - {\overline{α}}_{t}} {ϵ}_{θ} ( {h}_{t} , t ) ) + \sqrt{1 - {\overline{α}}_{t - 1}} {ϵ}_{θ} ( {h}_{t} , t )$ ${∇}_{{h}_{t}} log \tilde{p} ( \tilde{h} \vert {h}_{t} ) = \frac{1}{\sqrt{{\overline{α}}_{t}} ( {σ}^{2} + \frac{1 - {\overline{α}}_{t}}{{\overline{α}}_{t}} )} ( \tilde{h} - \frac{1}{\sqrt{{\overline{α}}_{t}}} {h}_{t} )$ |
| | ${h}_{t - 1} = {h}_{t - 1} + λ ( \sqrt{1 - {\overline{α}}_{τ - 1}} - \frac{\sqrt{{\overline{α}}_{τ - 1} ( 1 - {\overline{α}}_{t} )}}{\sqrt{{\overline{α}}_{t}}} ) {∇}_{{h}_{t}} log \tilde{p} ( \tilde{h} \vert {h}_{t} )$ |

end for
Output: h₀

Using the validation data set, the performance of the provided DDIM-based channel estimation method with different hyperparameters (including scaling factor for the likelihood score distribution λ, number of DDPM steps T, noise schedule {βₜ}_{0≤t≤T}, and DDIM subsequence selection scheme) can be compared and eventually the setting which has the best optimized performance can be selected.

Although FIG. 9 illustrates one example method for DDIM-based channel estimation 900, various changes may be made to FIG. 9. For example, while shown as a series of steps, various steps in FIG. 9 could overlap, occur in parallel, occur in a different order, occur any number of times, be omitted, or replaced by other steps.

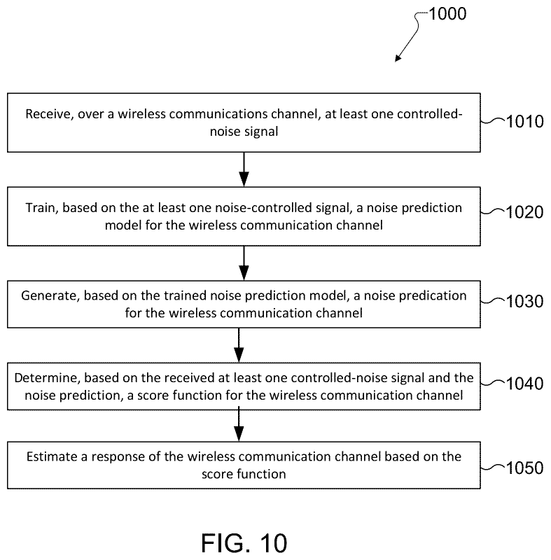

FIG. 10 illustrates an example method for diffusion model based wireless channel estimation 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments for diffusion model based wireless channel estimation could be used without departing from the scope of this disclosure.

In the example of FIG. 10, method 1000 begins at step 1010. At step 1010, an apparatus such as gNB 102 of FIG. 1, receives, over a wireless communication channel, at least one controlled-noise signal. For example, the apparatus may receive a simulated signal generated based on a model of the wireless communication channel, or may receive a controlled-noise signal from field measurements.

At step 1020, an apparatus, such as the apparatus of step 1010, or a different apparatus, trains, based on the at least one controlled-noise signal, a noise prediction model for the wireless communication channel. For example, the noise prediction model may be similar to noise predictor 406 of FIG. 4, noise predictor 606 of FIG. 6, or noise predictor 806 of FIG. 8.

At step 1030, an apparatus, such as the apparatus of step 1010, or a different apparatus, generates, based on the trained noise prediction model, a noise prediction for the wireless communication channel. For example, the noise prediction may be generated similar as described regarding FIGS. 4-9.

At step 1040, an apparatus, such as the apparatus of step 1010, or a different apparatus, determines, based on the received at least one controlled-noise signal and the noise prediction, a score function for the wireless communication channel. For example, the score function may be determined similar as described regarding FIGS. 4-9.

At step 1050, an apparatus, such as the apparatus of step 1010, or a different apparatus, estimates, a response of the wireless communication channel based on the score function.

In some embodiments of method 1000, the response of the wireless communication channel is estimated based on a Denoising Diffusion Probabilistic Model (DDPM) sampling process. For example, the estimation may be based on a DDPM sampling process similar as described regarding FIG. 4 and FIG. 5.

In some embodiments, method 1000 also includes estimating the response of the wireless communication channel based on the DDPM sampling process for a number of iterations M, and determining an average response of the wireless communication channel based on the M response estimations. For example, the average response of the wireless communication channel may be determined similar as described regarding FIG. 6 and FIG. 7. The average response of the wireless communication channel may be determined based on at least one of a mean or median of the M response estimations.

In some embodiments of method 1000, the response of the wireless communication channel is estimated based on a Denoising Diffusion Implicit Model (DDIM) sampling process. For example, the estimation may be based on a DDIM sampling process similar as described regarding FIG. 8 and FIG. 9.

Although FIG. 10 illustrates one example method for diffusion model based wireless channel estimation 1000, various changes may be made to FIG. 10. For example, while shown as a series of steps, various steps in FIG. 10 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An apparatus comprising:
a transceiver configured to receive, over a wireless communication channel, at least one controlled-noise signal; and
a processor, operatively coupled to the transceiver, the processor configured to:
train, based on the at least one controlled-noise signal, a noise prediction model for the wireless communication channel;
generate, based on the trained noise prediction model, a noise prediction for the wireless communication channel; and
determine, based on the received at least one controlled-noise signal and the noise prediction, a score function for the wireless communication channel.

2. The apparatus of claim 1, wherein the processor is further configured to estimate a response of the wireless communication channel based on the score function.

3. The apparatus of claim 2, wherein the response of the wireless communication channel is estimated based on a Denoising Diffusion Probabilistic Model (DDPM) sampling process.

4. The apparatus of claim 3, wherein the processor is further configured to:
estimate the response of the wireless communication channel based on the DDPM sampling process for a number of iterations M; and
determine an average response of the wireless communication channel based on the M response estimations.

5. The apparatus of claim 4, wherein the average response of the wireless communication channel is determined based on at least one of a mean or median of the M response estimations.

6. The apparatus of claim 2, wherein the response of the wireless communication channel is estimated based on a Denoising Diffusion Implicit Model (DDIM) sampling process.

7. The apparatus of claim 1, wherein the at least one controlled-noise signal is a simulated signal generated based on a model of the wireless communication channel.

8. A method comprising:
receiving, over a wireless communication channel, at least one controlled-noise signal;
training, based on the at least one controlled-noise signal, a noise prediction model for the wireless communication channel;
generating, based on the trained noise prediction model, a noise prediction for the wireless communication channel; and
determining, based on the received at least one controlled-noise signal and the noise prediction, a score function for the wireless communication channel.

9. The method of claim 8, further comprising estimating a response of the wireless communication channel based on the score function.

10. The method of claim 9, wherein the response of the wireless communication channel is estimated based on a Denoising Diffusion Probabilistic Model (DDPM) sampling process.

11. The method of claim 10, further comprising:
estimating the response of the wireless communication channel based on the DDPM sampling process for a number of iterations M; and
determining an average response of the wireless communication channel based on the M response estimations.

12. The method of claim 11, wherein the average response of the wireless communication channel is determined based on at least one of a mean or median of the M response estimations.

13. The method of claim 9, wherein the response of the wireless communication channel is estimated based on a Denoising Diffusion Implicit Model (DDIM) sampling process.

14. The method of claim 8, wherein the at least one controlled-noise signal is a simulated signal generated based on a model of the wireless communication channel.

15. A non-transitory computer readable medium embodying a computer program, the computer program comprising program code that, when executed by a processor of a device, causes the device to:
receive, over a wireless communication channel, at least one controlled-noise signal;
train, based on the at least one controlled-noise signal, a noise prediction model for the wireless communication channel;
generate, based on the trained noise prediction model, a noise prediction for the wireless communication channel; and
determine, based on the received at least one controlled-noise signal and the noise prediction, a score function for the wireless communication channel.

16. The non-transitory computer readable medium of claim 15, wherein the program code, when executed by the processor of the device, further causes the device to estimate a response of the wireless communication channel based on the score function.

17. The non-transitory computer readable medium of claim 16, wherein the response of the wireless communication channel is estimated based on a Denoising Diffusion Probabilistic Model (DDPM) sampling process.

18. The non-transitory computer readable medium of claim 17, wherein the program code, when executed by the processor of the device, further causes the device to:
estimate the response of the wireless communication channel based on the DDPM sampling process for a number of iterations M; and
determine an average response of the wireless communication channel based on the M response estimations,
wherein the average response of the wireless communication channel is determined based on at least one of a mean or median of the M response estimations.

19. The non-transitory computer readable medium of claim 16, wherein the response of the wireless communication channel is estimated based on a Denoising Diffusion Implicit Model (DDIM) sampling process.

20. The non-transitory computer readable medium of claim 15, wherein the at least one controlled-noise signal is a simulated signal generated based on a model of the wireless communication channel.
